(19) United States
(12) Patent Application Publication
(10) Pub. No.: US 2009/0067400 A1
(43) Pub. Date: Mar. 12, 2009

(54) METHOD OF SUPERVISING AT LEAST ONE TUNNEL SET UP FOR ROUTING PACKETS BETWEEN A MOBILE ROUTER AND A REFERRING EQUIPMENT ITEM IN A HOME NETWORK OF THE MOBILE ROUTER

(75) Inventors: David Binet, Blainville Sur Orne (FR); Frederic Klamm, Luc Sur Mer (FR); Brahim Gaabab, Toulouse (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, Paris (FR)

(21) Appl. No.: 12/279,993

(22) PCT Filed: Mar. 26, 2007
(86) PCT No.: PCT/FR07/51017

§ 371 Date: Aug. 20, 2008

(30) Foreign Application Priority Data
Mar. 27, 2006 (FR) 0651049

(51) Int. Cl. H04W 40/00

(52) U.S. Cl. 370/338

(57) ABSTRACT

A method supervises at least one tunnel set up for routing packets between a mobile router and a referring piece of equipment in a home network of the mobile router. The method detects a change in an availability state of the tunnel and sends notification of the change in the availability state of the tunnel to at least one node connected to the mobile router, and uses the tunnel set up for routing packets between itself and a network.

The invention relates to a technique for supervising at least one tunnel set up for routing packets between a mobile router and a referring piece of equipment in a home network of the mobile router.

The context here is managing the IP mobility of networks. In the following, mobile networks will be considered to be networks having the particular feature of being connected to the Internet via one or more routers, called mobile routers, which change their anchor points in the Internet topology. These are, for example, access networks used for passengers in public transport, sensor networks on board vehicles or personal area networks. The mobile IP protocol, called MIP in the following, allows the mobility of a mobile IP node to be managed, also called a Mobile Node or MN, from a home IP subnetwork to another IP subnetwork, called the visited network, when the node moves. Every IP node has a permanent address, HoA for Home Address, in its IP home network. When a node moves towards a visited network, it acquires a temporary address in this visited network, this address conventionally being called CoA for Care-of Address. The mobile node MN indicates this temporary address to a referring piece of equipment in its home IP network designated for managing the IP mobility. Such a piece of equipment is conventionally called a home agent, or also HA. In this manner, this home agent links the home address HoA in the home network and the temporary address CoA in the visited network. A bidirectional MIP tunnel is then employed between the home agent HA of the home network and the mobile node MN allowing the packets sent or received by the mobile node to be routed. It is thus able to receive packets intended for the permanent address HoA in the home network at the temporary address CoA. It is also able to transmit packets emitted from the temporary address CoA in such a way that they appear to be emitted from the home address HoA. Hence, due to the employment of this tunnel, it is possible to maintain an IP connection for a mobile node.

In this manner, an exchange of IP packets with the mobile IP node is possible, in a transparent manner with its movements, using the same destination IP address, i.e. the home address HoA, no matter what the location of the IP node.

The mobile node MN is either an IP terminal or a mobile router MR supporting terminals. In this latter case a mobile network is then said to consist of the mobile router and of nodes that are connected thereto. When a mobile router MR indicates the temporary address allocated to it to its home agent, it may also indicate the network prefix(es) attached to it. A network prefix covers a set of IP addresses managed by the mobile router. Hence, the home agent HA redirects to the mobile router MR all the packets intended for it and for the nodes connected to the mobile network, whether they are fixed or themselves mobile, by encapsulating them from the home agent HA to the mobile router MR. The redirection is carried out if the destination address of the packet is the home address of the mobile router or is part of the network prefix managed by the mobile router. The mobile router MR may also support a mobile node MN in its mobile network.

When there is a change in the availability state of the tunnel between the mobile router MR and its home agent HA, for example a break in the tunnel, a node residing in the mobile network or connected to this is not informed of the change in the tunnel availability state. This break may be linked, for example, with a physical connection problem with the visited network or indeed with a transmission problem between the visited network and the home network. Let us consider, for example, a node in communication with a data downloading service, i.e. a service active mainly in the downward direction, from the service to the node. When the node transmits a packet containing an acknowledgement for a set of received packets and it is impossible for the router to transmit packets in the tunnel, this transmitter node is notified, using a protocol message ICMP (for Internet Control Message Protocol), that it has not been possible to route the packet as the destination is inaccessible. The transmitter node is therefore informed only because it has addressed the mobile network in order to send a packet and the information it is provided with relates only to the routing of this particular packet and not an indication of a state of availability of the tunnel. The loss of the tunnel may also be detected by mechanisms at the level of the application software managing the service, these mechanisms also leading to deferred detection of the break in the tunnel. In the case of detecting unavailability on the tunnel, a mobile node may then trigger, on certain criteria, the setting up of a connection with another visited network, if one is detected. For the mobile node, a quick reaction is important in order to be able to preserve, if possible, contexts linked with the application software service.

A need therefore exists for a technique allowing a node connected to a mobile network to react quickly when the mobile router encounters a problem of availability of the tunnel set up with its home network.

The invention responds to this need by proposing a method for supervising at least one tunnel set up for routing packets between a mobile router and a referring piece of equipment in a home network of the mobile router, characterized in that it comprises:
a step of detecting a change in the tunnel availability state; and
a step of sending notification of the change in the tunnel availability state to at least one node connected to the mobile router and using the tunnel set up for routing packets between this itself and a network.

Hence, thanks to receiving notification of the change in the tunnel availability state a node is able to react quickly. In the case of a notification of unavailability of the tunnel, a fixed node attached to the mobile router may locally inform a software application service or a user. A mobile node itself may change into a state of searching then of setting up a connection with another mobile network. In the case of a notification of availability of the tunnel, a node may, for example, re-solicit a service that had been suspended. According to the invention, the nodes have therefore been spontaneously informed of a change in the tunnel availability state, without having the need to transmit a request to this end.

Advantageously, said sending step is implemented only at the end of a predetermined duration during which no new change in the tunnel availability state has been detected.

The notification of the change in the tunnel availability state is only transmitted when a state of unavailability has been detected for a sufficiently long period, i.e. greater than a predetermined duration, in order to avoid sending successive notifications of the change in the tunnel availability state.

Preferably, the method additionally comprises a step of rebroadcasting the notification to at least one second order node connected indirectly to the mobile router by means of a node that has received the notification.

Hence, through the rebroadcasting of the notification of the change in the tunnel availability state, all the nodes connected to the mobile router, including those connected to it indirectly and using the tunnel, are informed of the change in the tunnel availability state and are able to react quickly to this notification.

The invention also relates to a mobile router able to set up a tunnel for routing packets with a referring piece of equipment from a home network to which it belongs when it is connected to a visited network, characterized in that it comprises:
means for detecting a change in the tunnel availability state; and
means for sending a notification of the change in the tunnel availability state to at least one node connected to the mobile router and using the tunnel set up for routing packets between this itself and a network, fed by said detection means.

The invention also relates to a node connected to a mobile router, routing of packets between the node and a network being carried out by at least one tunnel set up between the mobile router and a referring piece of equipment in a home network of the mobile router, characterized in that it comprises:
reception means, set up to receive a notification of the change in the tunnel availability state.

The invention also relates to a signal bearing a message of notification of the change in the availability state of at least one tunnel, emitted by a mobile router destined for at least one node connected to the mobile router, said tunnel being set up for routing packets between the mobile router and a referring piece of equipment in a home network of the mobile router, characterized in that it comprises a tunnel identifier and a field representing a tunnel availability state.

The invention will be better understood with the help of the following description of a particular embodiment of the method of the invention, with reference to the appended drawings in which:

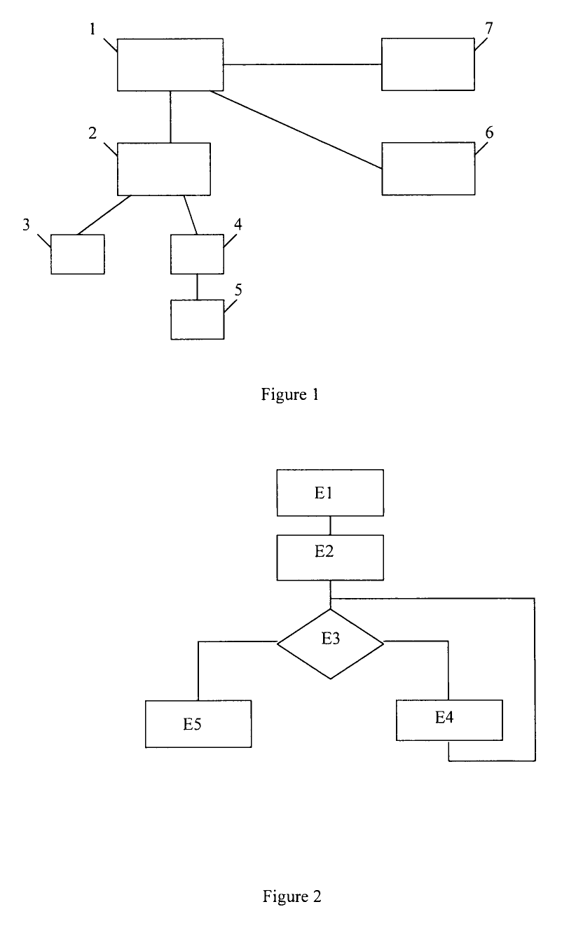

FIG. 1 shows a diagram of a network architecture;

FIG. 2 illustrates a method for supervising a tunnel according to an embodiment of the invention;

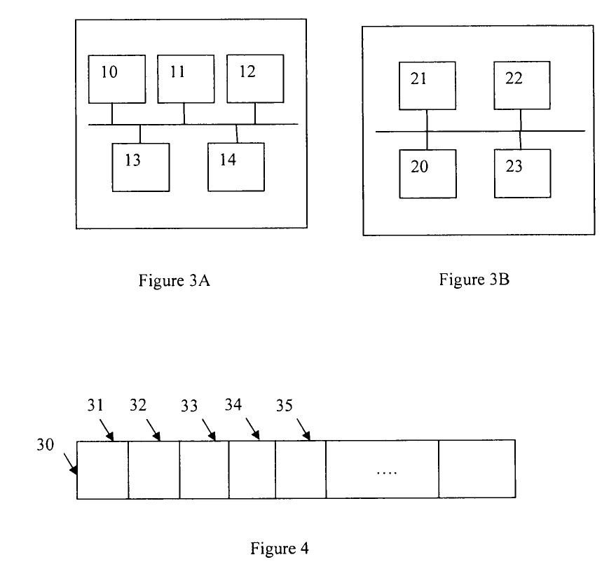

FIG. 3A shows a mobile router according to the invention;

FIG. 3B shows a node according to the invention; and

FIG. 4 shows a message of notification of a change in the availability state according to the invention.

Mobility in the Internet is generally considered to be the ability to move while remaining connected to an access network by means of a piece of equipment.

The set of nodes located at the same logical link constitutes a subnetwork. For each subnetwork there is a corresponding prefix, called the network prefix, which enables the position of the subnetwork in the hierarchy of the Internet to be identified. In the following, the terms network and subnetwork will be used indiscriminately.

FIG. 1 shows a diagram of a network architecture. A mobile router 2 is connected to the network IP 1. This router 2 is mobile within the Internet and has set up a connectivity with the network IP 1 by means of a visited network, not shown in FIG. 1. The mobile router 2 has a home IP address HoA1 in its home network, not shown in FIG. 1. The home address corresponds to an address identifying the node. It has obtained a temporary address CoA1, called CoA for Care-of address, in the visited network. The temporary address corresponds to an address localizing the node in the architectures of the IP network. This temporary address belongs to the addresses attributed to the visited network. The physical layers used for setting up the connection with the IP network may be of various types of wired or wireless technologies: cellular, satellite, IEEE 802.11b, etc. When the IP connectivity is set up, the mobile router 2 contacts a referring piece of equipment 6 belonging to its home network and transmits to it the temporary address CoA1 which it has obtained in the visited network as specified by the IETF (Internet Engineering Task Force) in the RFC 3775 with the help of a Binding Update message. The referring piece of equipment 6 manages the association of home address and temporary address (HoA1-CoA1). Every packet destined for the mobile router 2 is routed by the network towards the referring piece of equipment 6 which encapsulates the packet and routes the encapsulated packet to the visited network. The latter deals with routing the packet through to the mobile router 2. Every packet sent by the mobile router 2 is transmitted as if it had been emitted from the home address HoA1. It will now be assumed that a bidirectional tunnel TU for routing packets has been set up between the referring piece of equipment 6 and the mobile router 2.

The mobile router 2 may support terminals, called fixed terminals, that are connected directly or indirectly thereto, i.e. not having the ability to set up a connectivity with a visited network. It indicates to the referring piece of equipment 6 that it is offering the routing function in the Binding Update message conforming to the IETF's RFC 3963. Such a fixed terminal is shown in FIG. 1 under the reference 3. The mobile router 2 may also indicate the network prefix(es) it manages in the same Binding Update message. The referring piece of equipment 6 of the mobile router 2 then takes charge of the routing of the packets destined for all the addresses belonging to the network prefix managed by the mobile router 2 by using the set up tunnel TU.

The mobile router 2 supports a node 4 having routing abilities. A mobile node 5 is attached to the node 4. It obtains a temporary address CoA2 belonging to the network prefix managed by the mobile router from the mobile router 2 and transmits this to its referring piece of equipment 7 in its own home network. Hence the packets destined for the mobile node 5 are routed to the referring piece of equipment 7 of the mobile node 5, retransmitted by this to the referring piece of equipment 6 of the mobile router 2, then to the mobile router 2 by using the tunnel TU set up between the referring piece of equipment 6 and the mobile router 2.

Two levels of mobility are shown in FIG. 1 by way of example. It is possible to have a higher number of mobility levels. Mobile nodes may also be connected directly to the mobile router 2.

The method for supervising at least one tunnel set up for routing packets between a mobile router and a referring piece of equipment will now be described with reference to FIG. 2. By way of example, the bidirectional tunnel TU set up between the mobile router 2 and the referring piece of equipment 6 will be supervised.

A first step E1 of the method consists in continuously supervising the availability state of a tunnel. This supervision is carried out by mechanisms internal to the mobile router which will not be detailed here. It may, for example and in a nonexhaustive manner, be processing of notifications emitted by physical layers, alarms received signaling failure of a physical card, problems with the link between the visited network and the home network of the mobile router, etc. These notifications might possibly only affect one direction of the tunnel but ultimately have an impact on the availability state of the tunnel as a whole.

If the tunnel availability state remains stable, the step E1 remains continuously active.

If the tunnel availability state passes from the “available” to the “unavailable” state or vice versa, a second step E2 of sending a notification of a change in state of the tunnel is then progressed to.

In this second step E2 a message 30 of notification of the change in the availability state of the tunnel TU is sent to at least one node connected to the mobile router 2. This notification message comprises at least an identifier 35 of the tunnel concerned and a field 34 representing a tunnel availability state.

According to a first embodiment, the Neighbor Discovery Protocol specified in RFC 2461 from the IETF may be used to carry such a message. Thus it involves appending an additional binary element indicating the tunnel state, depending on its value, to the Neighbor Advertisement message. In this case, the tunnel identifier is implicitly included in the message, as the message is sent by the mobile router 2.

According to a second embodiment, a new type of protocol is defined to be able to allow transmission of general information in the mobile network between the mobile router and the nodes which are connected to it. In the case of the message 30 of notification of a change in the tunnel availability state, such a message comprises the following information elements, with reference to FIG. 4:
an information element 31 comprising a protocol identification;
an information element 32 comprising an identification of the transmitter of the message;
an information element 33 comprising an identification of at least one message destination node in a mode called unicast, or an overall identification of the mobile network, i.e. all the connected nodes, in a mode called multicast or broadcast;
an information element 34 comprising a tunnel availability state, “available” or “unavailable”.

The identification of the tunnel concerned is implicit in the case in which a single tunnel is set up. Optionally, the message 30 includes an information element 35 bearing an identifier of the tunnel for which the change in availability state is notified.

Optional elements may also be included in order to complete the information relating to the tunnel, for example and in a nonexhaustive manner:
an information element comprising a piece of information about the physical interface underlying the tunnel;
an information element comprising a piece of temporal information about the time passed between the detection of a change in the tunnel availability state giving rise to the sending of this message and the actual sending of the message;
an information element comprising a description of the tunnel characteristics, for example, the data rate of the tunnel, a piece of temporal information about the passed duration of tunnel activity, the address of the referring equipment, etc.; and
an information element TTL, for Time To Live, defining the number of possible rebroadcastings of the notification message.

As a variant, the sending of the notification message at step E2 is deferred. At the end of the step E1 a timer is set to a predetermined value. As long as the timer has not expired, the supervision of the tunnel availability state continues. If a new change in the tunnel availability state has been detected before expiration of the timer, the method stops the timer and returns to the step E1 of supervising the tunnel availability state. When the timer has expired, the tunnel availability state has remained in a stable “available” or “unavailable” state throughout this entire period. The message of notification of a change in the tunnel state is then sent. The predetermined value is chosen in such a way that the sending of the message is sufficiently deferred so as not to be triggered when the tunnel availability state is not in a stable state, and this sending is nonetheless carried out quickly enough to allow a node comprising means of searching for a new network to be able to do this and hence to preserve its application contexts.

At the end of this step E2 of sending notification of a change in the tunnel availability state and during a third test step E3, a test is carried out aiming to detect whether the message destination node has routing abilities. If this is not the case, a fifth decision-making step E5 is progressed to. In the opposite case, for example in the case of the router node 4, a fourth step E4 is progressed to, a step of rebroadcasting the message of notification of a change in the tunnel availability state to at least one second order node 5 connected to this router node 4 and hence indirectly to the mobile router 2. As a variant, if the message of notification of a change in the availability state includes the information element TTL, described above, and only if its value is nonzero, this fourth step is progressed to while decrementing the value of the information element TTL in the notification message.

At the end of this fourth step E4, the test step E3 is returned to in order to apply it to the second order node 5.

In a fifth decision-making step E5, the message of notification of a change in the tunnel availability state is taken into account by the node and this latter decides on the actions to be carried out. In the case of notification of tunnel unavailability, the fixed node 3 attached to the mobile router 2 may inform a application service or a user. A node comprising means of searching for a new network, for example the node 5, may take any action in order to connect, for example, to a new network.

In the case of notification of tunnel availability, the message of notification of a tunnel availability state also enables a node that has remained connected to the mobile network, either because it does not comprise searching means or because it has decided to remain on the mobile network or in any other case, to be notified that the tunnel availability state has returned to the “available” state. This node may for example re-solicit a service that had been suspended.

A mobile router 2, as shown in FIG. 3A, comprises:
means 10 for setting up a physical connection with a visited network, these means possibly being of various types of wired or wireless technology, such as cellular, satellite, IEEE 802.11b, etc.;
means 11 for setting up a tunnel for routing packets with a referring piece of equipment from a home network to which it belongs when it is connected to a visited network;
means 12 for searching for a visited network.

It also comprises, according to an embodiment of the invention:
means 13 for detecting a change in the tunnel availability state implementing the step E1 of the method; and
means 14 for sending a notification of the change in the tunnel availability state to at least one node connected to the mobile router. These sending means 14 implement the step E2 of the method and are fed by the detection means 13.

A node 3, 4, 5, as shown in FIG. 3B, connected to a mobile router 2, described above, comprises:
reception means 20, set up to receive a notification of a change in the tunnel availability state.

Following reception of the notification of a change in the tunnel availability state, it may inform a software application of this change.

Optionally, such a node 5 provided with means 21 for setting up a physical connection with a visited network also comprises means 22 of searching for a new network. These means 22 of searching for a new network are triggered following reception of the notification of a change in a tunnel availability state.

In the case in which a node 4 ensures the routing function for other nodes, it additionally comprises:
rebroadcasting means 23 set up to rebroadcast the notification of a change in the tunnel availability state. These rebroadcasting means 23 implement the step E4 of the method.

The modules which implement the previously described method are preferably software modules comprising software instructions in order to have the steps of the previously described method executed by the server. The software modules may be stored in or transmitted by a data medium. The latter may be a material storage medium, for example a CD-ROM, a magnetic disk or a hard disk, or indeed a transmission medium such as an electrical, optical or radio signal, or a telecommunications network.

1-9. (canceled)

10: A method for supervising at least one tunnel set up for routing packets between a mobile router and a referring piece of equipment in a home network of the mobile router, the method comprising:
detecting a change in an availability state of the tunnel; and
sending notification of the change in the availability state of the tunnel to at least one node connected to the mobile router and using the tunnel set up for routing packets between itself and a network.

11: The method as claimed in claim 10, wherein the sending is implemented only at an end of a predetermined duration during which no new change in the availability state of the tunnel has been detected.

12: The method as claimed in claim 10, further comprising rebroadcasting the notification to at least one second order node connected indirectly to the mobile router by a node that has received the notification.

13: The method as claimed in claim 10, wherein the notification of the change in the tunnel state is sent in broadcast mode to nodes connected to the mobile router.

14: A mobile router configured to set up a tunnel for routing packets with a referring piece of equipment from a home network to which it belongs when it is connected to a visited network, comprising:
means for detecting a change in an availability state of the tunnel; and
means for sending a notification of the change in the availability state of the tunnel to at least one node connected to the mobile router and using the tunnel set up for routing packets between itself and a network, fed by the means for detecting.

15: A node connected to a mobile router, routing of packets between the node and a network being carried out by at least one tunnel set up between the mobile router and a referring piece of equipment in a home network of the mobile router, the node comprising:
reception means set up for receiving a notification of a change in an availability state of the tunnel.

16: The node as claimed in claim 15, further comprising means for searching for a new network.

17: The node as claimed in claim 15, ensuring the router function for second order nodes connected indirectly to the mobile router by the reception means, and further comprising:
rebroadcasting means for rebroadcasting the notification of the change in the availability state of the tunnel.

18: A signal bearing a message of notification of a change in an availability state of at least one tunnel, emitted by a mobile router destined for at least one node connected to the mobile router, the tunnel being set up for routing packets between the mobile router and a referring piece of equipment in a home network of the mobile router, the signal comprising:
a tunnel identifier and a field representing a tunnel availability state.
